(19) United States
(12) Patent Application Publication
(10) Pub. No.: US 2021/0390600 A1
(43) Pub. Date: Dec. 16, 2021

(54) SYSTEM AND METHOD FOR FACILITATING A CONSUMER-DRIVEN MARKETPLACE FOR SELLERS

(71) Applicant: Barker, LLC, Dallas, TX (US)

(72) Inventor: Scott Norman, Dallas, TX (US)

(73) Assignee: Barker, LLC, Dallas, TX (US)

(21) Appl. No.: 17/078,421

(22) Filed: Oct. 23, 2020

Related U.S. Application Data
(60) Provisional application No. 63/038,699, filed on Jun. 12, 2020.
(60) Provisional application No. 63/068,347, filed on Aug. 20, 2020.

(51) Int. Cl. G06Q 30/06; G06Q 30/02; G06Q 50/26; G06Q 20/38; G06Q 50/18; G06Q 30/08; G06Q 30/00; G06Q 40/04; G06F 21/62

(52) U.S. Cl. CPC G06Q 30/0611; G06Q 30/0201; G06Q 50/265; G06Q 20/383; G06Q 30/0277; G06Q 50/16; G06Q 30/08; G06Q 30/0185; G06Q 40/04; G06F 21/6254; G06Q 2220/00; G06Q 50/188

(57) ABSTRACT

A system for facilitating a consumer-driven marketplace for sellers. The system electronically receives requirement information of a consumer for a requested asset. The system also electronically receives qualification information of the consumer for the requested asset. The system further electronically communicates at least some of the requirement information and qualification information of the consumer to one or more sellers to allow the one or more sellers to communicate an offer to the consumer.

### RELATED APPLICATIONS

This application claims priority to U.S. Provisional Application No. 63/038,699 filed on Jun. 12, 2020 and U.S. Provisional Application No. 63/068,347 filed on Aug. 20, 2021. U.S. Provisional Application Nos. 63/038,699 and 63/068,347 are incorporated by reference for all purposes.

### TECHNICAL FIELD

This disclosure is generally directed to consumer and seller interactions. More specifically, this disclosure is directed to a system and method for facilitating a consumer-driven marketplace for sellers.

### BACKGROUND

There are dozens of different consumer-seller protocols in use today. However, almost all of those systems are seller-driven in the sense that they focus on the methods and processes available to the seller, allowing it to advertise products (including real estate, apartments, storage units and vehicles) to consumers generally without regard to the particulars of a consumer. Internet advertising sites, classified advertisements and other marketing are all seller-driven. Traditionally, it is the seller's job to attract consumers on a general basis and then after the consumer is attracted, qualify the consumer and then endeavor to consummate a rental/lease/sale transaction. Thus, in a seller-driven system, the advertising cost of the transaction and the attendant risks that such advertising will be unsuccessful falls upon the seller.

### SUMMARY OF THE DISCLOSURE

Given the short-comings describe herein, the disclosure provides a system and method for facilitating a consumer-driven marketplace for sellers.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “seller” includes any purveyor of real property, goods or services, including car dealers, landlords, insurance companies and other vendors; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C. Definitions for certain words and phrases are provided throughout this patent document, those of ordinary skill in the art should understand that in many if not most instances, such definitions apply to prior, as well as future uses of such defined words and phrases.

### BRIEF DESCRIPTION OF THE DRAWINGS

For a more complete understanding of this disclosure and its features, reference is now made to the following description, taken in conjunction with the accompanying drawings, in which:

FIG. 1 is a simplified block diagram illustrative of a communication system that can be utilized to facilitate communication between endpoints through a communication network, according to particular embodiments of the disclosure;

FIG. 2 is an embodiment of a general-purpose computer that may be used in connection with other embodiments of the disclosure to carry out any of the herein-referenced functions and/or serve as a computing device for endpoints and endpoints of FIG. 1;

FIG. 3 is block diagram of a system, according to an embodiment of the disclosure;

FIG. 4 shows further features of the cloud component of FIG. 3;

FIG. 5 illustrate a process of consumer creating a lead, according to an embodiment of the disclosure;

FIG. 6 illustrate a process of seller bidding on consumer lead, according to an embodiment of the disclosure; and

FIG. 7 is a simplified diagram of multiple sellers bidding on a particular consumer

### DETAILED DESCRIPTION

The FIGURES described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

As referenced earlier, there are dozens of different seller-consumer protocols in use today. However, almost all of those systems are seller-driven in the sense that they focus on the methods and processes available to the seller, allowing it to generally advertise their products and services to the general public without regard to the requirements and qualifications of a particular consumer. They generally apply a one-size fits all approach. Internet advertising sites, classified advertisements and other marketing are all seller-driven. Traditionally, it is the seller's job to attract consumers on a general basis and then after the consumer is attracted, qualify the consumer and then endeavor to consummate a transaction. Thus, in a seller-driven system, the advertising cost of the transaction and the attendant risks that such advertising will be unsuccessful falls upon the seller.

Most transactions that require a consumer's personal information are entered pursuant to a general seller-driven protocol, whereby the seller sets a price only after evaluating a consumer's personal information, at which point the consumer then must decide whether or not to accept that price. A seller's price can range depending on the attributes of a particular consumer as well as a particular seller's then available or expected inventory. In the real estate rental context, the consumer's credit quality and leasing demands, including the particular commencement date and expiration date of the rental, can impact pricing. If a consumer's lease will commence on a date that requires seller to hold a unit vacant for an extended period of time, pricing will be affected. In the residential rental unit context, an expiration date in the fall (low rental season) can also affect pricing because a seller must expect that the rental unit will remain vacant through the holiday season. Lastly, the consumer's credit, income and rental/lease history can dramatically impact pricing of a rental, lease or insurance product. Despite this, the vast majority of rental/leasing businesses still utilize the seller-driven pricing protocols, advertising to the market in general in an effort to attract an acceptable consumer.

Auctions to obtain particular consumers do not exist in the current market. Traditionally, auctions pertain to products and services where prices are not fixed by the seller. Here too, the system is seller-driven. The consumer does not find the seller. Rather the seller attracts numerous consumers who, as a group, determine the final selling price—which the seller may subsequently reject unless the item auctioned is being sold without a reserve.

There are currently no consumer-driven systems where sellers find consumers, such as a “wanted to rent” classified ad, where a seller can look to locate and sell to a pre-screened consumer that is interested in seller's particular product type.

A consumer-driven system geared toward each unique consumer would yield certain benefits and efficiencies that other commerce systems do not. Consumers could use such a system to anonymously advertise/promote their requirements and qualifications (i.e., credit score, salary history, etc.) to multiple sellers in order to achieve the most competitive pricing and exercise more control over the terms and conditions of their rental/lease. Additionally, when a large number of potential sellers exist, but those sellers do not have the resources to advertise globally, it makes sense for consumers, if they can, to take the initiative in communicating its qualifications and needs to the sellers, effectively creating a consumer marketplace for sellers.

Bilateral consumer-driven systems seek to consummate contracts between consumers and sellers based on mutual promises to perform. Bilateral consumer-driven systems, however, currently represent an extremely small portion of overall commerce due to a variety of factors. First, and perhaps foremost, consumers generally either cannot or do not want to invest the time, money or other resources required to make application to an indefinite number of potential sellers and communicate the consumer's rental/leasing needs to each of the potential sellers. This is especially true of the individual consumer in the real estate rental context who often cannot afford to pay the substantial transaction costs that would be associated with such an effort (i.e., multiple application fees).

For example, an individual seeking a rental/lease of an apartment generally would prefer to avoid haggling with multiple landlords and filling out multiple credit applications. The benefits to the consumer from doing so (e.g., achieving a lower price) would be vastly outweighed by the amount of time, stress and money expended (e.g., multiple applications) in the effort. Similarly, an individual seeking to lease a car generally would prefer to avoid the time and effort associated with going to multiple dealers and filling out multiple credit applications in order to obtain an accurate car lease quote.

Also, consumer-driven systems are not prevalent because there is no effective way for a consumer to communicate its particular confidential consumer requirements and qualifications to multiple sellers without compromising its confidential information (i.e., credit score, salary, etc.) and without getting inundated with numerous offers from potential sellers, many of whom may be marginal or unqualified (e.g. a thousand car dealers or real estate brokers or sellers all calling one consumer). Consumer-driven systems impose inherent costs on sellers as well. If each consumer has a different set of requirements and communicates its needs using non-uniform language, sellers must pay a substantial cost even to review and understand each individual request. Moreover, sellers are often not amenable to customizing their terms for individual consumers.

As a rule, the greater the number and complexity of the consumer's conditions and areas of interest, the more difficult it is to have a consumer-driven market, since advertising costs generally rise with the number of conditions that must be communicated, and the potential number of sellers who can understand and fulfill increasingly complex conditions usually declines. Consumer-driven markets function best when there is a well-defined purchase need, when a “brand” provides quality assurance to the consumer such as when the item is a commodity such as oil or coal.

An example of a regularly used bilateral buyer-driven process is the system utilized by large organizations such as companies or governments that want to purchase significant amounts of goods or services at the lowest possible price. To begin, they formulate a detailed written specification setting forth the quantities and requirements of what they are looking to buy. This document is typically called a “Request for Proposal” (RFP). Once finalized, RFPs are then distributed to a list of known potential suppliers. If the value of the RFP is high enough, as it is might be with a large government contract, the buyer may bear the added expense of trying to attract the widest number of sellers by paying to publish the RFP in newspapers and trade magazines. Confidential consumer credit information is not a concern with large companies issuing such RFP's.

Potential suppliers which identify an RFP that they might be able to fulfill, will first evaluate it and the buyer to decide whether or not to invest the necessary time and effort to submit a formal proposal. Typically, some number of suppliers submit binding proposals to the buyer by a deadline established in the RFP. Once submitted, proposals are then evaluated by the buyer. One proposal is usually selected and the corresponding supplier notified that it has “won” the business at the price quoted.

Large organizations can take advantage of the benefits afforded by the REP process because their credit is known and their volume buying represents a worthwhile opportunity for suppliers to compete for their business. They also have the resources to communicate their buying needs to a sufficient number of suppliers. As a result, they can often achieve substantial unit cost savings, especially on commodities or commodity services (such as paper clips or long-distance service) and on perishable items.

Individual consumers cannot effectively participate in such bilateral buyer-driven systems because they generally do not have the reputation, buying power, credit and resources of large organizations and their creditworthiness cannot be evaluated without divulging confidential information. Some consumers have found ways to group together in order to achieve some measure of the volume buying power enjoyed by large organizations, but under such a scenario, the group would have to have identical needs.

While there have been some attempts to use the Internet to effectuate bilateral consumer-driven transactions, those attempts have been largely unsuccessful. Currently, there are “bulletin board” type sites such as on the Internet such as Craiglist where consumers can post “wanted” advertising at little or no cost. Thus, any consumer could post his own RFP looking for companies willing to rent the exact unit for which they are looking. Sellers are deterred from using such a process because there is no guarantee of the authenticity of the REP, the cost of negotiating with individual consumers is often too high, and it is not possible to underwrite the consumer until the consumer makes a complete application. Additionally, “bulletin boards” containing RFPs are scattered across the Internet making it difficult, if not impossible, for sellers to find relevant and authentic RFPs, Finally, when analyzing the RFPs that are posted on the Internet, sellers are confronted by an almost overwhelming number of different formats, conditions, terms, and language styles in the RFPs. Sellers must spend a large amount of time and money even simply to understand the prospective consumer's needs and requirements. In sum, consumer RFPs posted on the Internet represent too much uncertainty for sellers. Sellers are not willing to spend the time and money finding and pursuing Internet RFPs. In turn, the absence of a critical mass of sellers reduces the incentive for consumers to post their RFPs.

Accordingly, there is a need for a centralized consumer-driven system of bilateral electronic commerce capable of being utilized by the individual consumer to anonymously and credibly communicate their qualifications and requirements to multiple sellers which addresses the deficiencies of the prior art. The advantages of such a system are manifest. It is the only way for a consumer to anonymously and efficiently communicate his/her personal consumer information and terms to a large market of potential sellers. It also allows the consumer to set the terms it is willing to accept. As an additional advantage, it gives the sellers an indication of the state of the market for their product. Sellers could have visibility into offers made by other sellers, thereby creating a competitive marketplace that delivers the best pricing for the consumer. Since this technology is electronically based, costs are kept to a minimum.

Finally, because the consumer's qualifications and terms are communicated anonymously, sellers can engage in negotiations in full compliance with applicable discrimination laws, including the Regulation B/Equal Credit Opportunity Act and Fair Housing Act. Under traditional seller driven models, some consumers may fear discrimination based upon their race, religion, color, sex, national origin, disability or familial status. Additionally, sellers face increasing risks of civil actions, class actions, regulatory penalties and reputational risk associated with any failure to comply with these Acts. Under the proposed Consumer-driven system, prior to making an offer, a seller will not know the identity, race, religion, color, sex, national origin, disability or familial status of the prospective consumer, resulting in a ve y effective risk mitigant for the parties. Essentially, a consumer can anonymously advertise its good credit, rental/lease and job history and other attractive traits to multiple sellers to obtain the best possible pricing. A seller with available inventory of a product could immediately access the “consumer market” to view pre-screened consumers interested in purchasing/renting/leasing their product and immediately make an offer to such consumer.

An element that will assist in achieving critical mass of seller participation in such a bilateral electronic consumer-driven system is the seller's ability to bind a consumer to a legal contract under the terms of the seller's offer. In contrast to a non-binding request for proposal, consumer's acceptance of a binding offer from a seller is attractive to potential sellers because seller's offer will set out each and every term and condition under which the seller will allow itself to be bound. Potential sellers do not need to worry about the costs of negotiating terms with the individual consumer because the consumer has previously specified all such terms. Additionally, allowing a consumer to bind the seller on the front end of the transaction will alleviate some consumer concerns regarding enforcement because the consumer has the opportunity to bind the seller to a legally enforceable contract.

With recent pandemics, social unrest and the advent of new technology, methods of doing business are rapidly evolving. These new methods challenge traditional contract principles, which are premised on personal contact and paper contracts.

No commercially-viable bilateral consumer-dr yen commerce system which contains the above features and addresses the above-described shortcomings in the prior art. Therefore, according to an embodiment of the disclosure, a system of bilateral consumer-driven electronic commerce that offers the capability for individual consumers to issue authenticatable messages that contain a summary of their unique qualifications (i.e., credit score, salary history, etc.) and requirements and anonymously promote such to multiple potential sellers. Sellers would have the opportunity to review such unique qualifications and requirements to make their most competitive offers to the consumer, which offer would be free from influence from factors that should not be considered (i.e., race, religion, color, sex, national origin, disability or familial status).

A benefit of certain embodiments would allow a seller to view offers from other sellers to create a competitive bidding process that allows the consumer to achieve the best possible pricing.

A benefit of certain embodiments is the ability to allow a consumer to transmit its qualifications (i.e., credit score, salary history, etc.) and requirements in a manner that does not identify the consumer by name, race, religion, color, sex, national origin, disability or familial status until it has accepted an offer from the seller, which assures the consumer is not inundated with unwanted offers/contacts and is otherwise treated in compliance with all applicable discrimination laws.

A benefit of certain embodiments is the ability to allow a consumer to bind a seller that has provided the best offer to the consumer.

A benefit of yet further embodiments is the ability to allow the seller to be able to collect any deposit immediately upon consumer's acceptance of seller's offer (as evidenced by consumer's execution of the rental/lease contract provided by seller with their offer).

A benefit of yet further embodiments is the ability to ensure that consumers using the inventive system are not inundated with inquiries or acceptances from unqualified sellers.

A benefit of yet further embodiments is the ability to provide a system in Which the identity of the consumer is authenticated along with the integrity of the consumer (i.e., credit screening).

A benefit of yet further embodiments is the ability to provide a system in which the identity of the seller is authenticated in order to determine the seller's capacity to satisfy consumer's requirements.

A benefit of yet further embodiments is the ability to allow consumers to submit authenticatable counteroffers to the seller.

A benefit of yet further embodiments is the ability to allow counteroffers that may allow seller to bind consumer to the counteroffer, subject to the authenticatable terms of that counteroffer.

A benefit of yet further embodiments is the ability to allow for delivery of digitally-based products according to the terms of the seller's offer and the cryptographic validation of such delivery.

A benefit of yet further embodiments is the ability to show how all or part of the system can be practiced using non-electronic means such as printed media or advertisements in newspapers.

These and other benefits of other embodiment will be apparent to those skilled in the art from the following detailed description of the invention, the accompanying drawings and the appended claims. While certain benefits have been described, it should be understood that some or none of the above-described benefits may be present in certain embodiments.

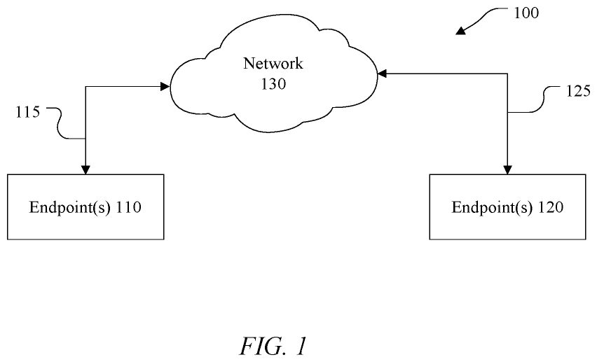

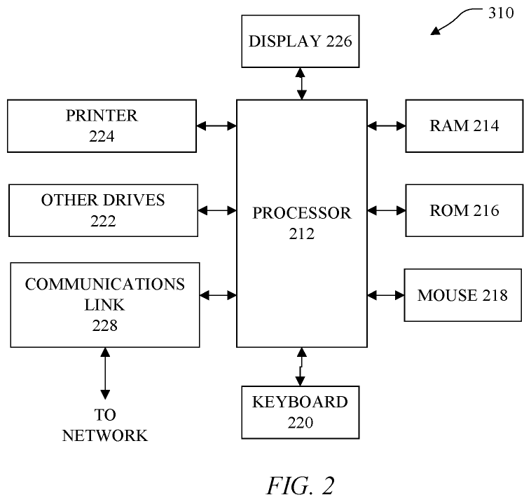

FIGS. 1 and 2 describe non-limiting examples of communications and computers that may be utilized in conjunction with the concepts described reference to the other embodiments described herein.

FIG. 1 is a simplified block diagram illustrative of a communication system 100 that can be utilized to facilitate communication between endpoint(s) 110 and endpoint(s) 120 through a communication network 130, according to particular embodiments of the disclosure. When referencing communication, for example, showing arrows or “clouds,” or “networks,” any of such communication may occur in the manner described below or other manners. Likewise, the endpoints may generally correspond to any two particular components described (or combination of component) with another component or combination of components.

As used herein, “endpoint” may generally refer to any object, device, software, or any combination of the preceding that is generally operable to communicate with and/or send information to another endpoint. In certain configurations, the endpoint(s) may represent a user, which in turn may refer to a user profile representing a person. The user profile may comprise, for example, a string of characters, a user name, a passcode, other user information, or any combination of the preceding. Additionally, the endpoint(s) may represent a device that comprises any hardware, software, firmware, or combination thereof operable to communicate through the communication network 130.

Examples of an endpoint(s) include, but are not necessarily limited to those devices describe herein, a computer or computers (including servers, applications servers, enterprise servers, desktop computers, laptops, netbooks, tablet computers (e.g., IPAD), a switch, mobile phones (e.g., including IPHONE and Android-based phones), networked televisions, networked watches, networked glasses, networked disc players, components in a cloud-computing network, or any other device or component of such device suitable for communicating information to and from the communication network 130. Endpoints may support Internet Protocol (IP) or other suitable communication protocols. In particular configurations, endpoints may additionally include a medium access control (MAC) and a physical layer (PHY) interface that conforms to IEEE 801.11. If the endpoint is a device, the device may have a device identifier such as the MAC address and may have a device profile that describes the device. In certain configurations, where the endpoint represents a device, such device may have a variety of applications or “apps” that can selectively communicate with certain other endpoints upon being activated.

The communication network 130 and links 115, 125 to the communication network 130 may include, but is not limited to, a public or private data network; a local area network (LAN); a metropolitan area network (MAN); a wide area network (WAN); a wireline or wireless network (WIFI, GSM, CDMA, LTE, WIMAX, BLUETOOTH or the like); a local, regional, or global communication network; portions of a cloud-computing network; a communication bus for components in a system; an optical network; a satellite network; an enterprise intranet; other suitable communication links; or any combination of the preceding. Yet additional methods of communications will become apparent to one of ordinary skill in the art after having read this specification. In particular configuration, information communicated between one endpoint and another may be communicated through a heterogeneous path using different types of communications. Additionally, certain information may travel from one endpoint to one or more intermediate endpoint before being relayed to a final endpoint. During such routing, select portions of the information may not be further routed. Additionally, an intermediate endpoint may add additional information.

Although endpoint generally appears as being in a single location, the endpoint(s) may be geographically dispersed, for example, in cloud computing scenarios. In such cloud computing scenarios, and endpoint may shift hardware during back-up. As used in this document, “each” may refer to each member of a set or each member of a subset of a set.

When the endpoints(s) 110, 130 communicate with one another, any of a variety of security schemes scheme may be utilized. As an example, in particular embodiments, endpoint(s) 120 may represent a client and endpoint(s) 130 may represent a server in client-server architecture. The server and/or servers may host a website. And, the website may have a registration process whereby the user establishes a username and password to authenticate or log in to the website. The website may additionally utilize a web application for any particular application or feature that may need to be served up to web site for use by the user.

A variety of embodiments disclosed herein may avail from the above-referenced communication system or other communication systems.

FIG. 2 is an embodiment of a general-purpose computer 210 that may be used in connection with other embodiments of the disclosure to carry out any of the herein-referenced functions and/or serve as a computing device for endpoint(s) 110 and endpoint(s) 120 of FIG. 1. In executing the functions described herein, the computer is able to things it previously could not do.

General purpose computer 210 may generally be adapted to execute any of the known OS2, UNIX, Mac-OS, iOS, Linux, Android and/or Windows Operating Systems or other operating systems. The general-purpose computer 210 in this embodiment includes a processor 212, random access memory (RAM) 214, a read only memory (ROM) 216, a mouse 218, a keyboard 220 and input/output devices such as a printer 224, drives 222, a display 226 and a communications link 228. In other embodiments, the general-purpose computer 3210 may include more, less, or other component parts. As a non-limiting example, where the general-purpose computer 210 is a server in a server-farm, such a sever would likely not include a printer, a mouse, a display, or a keyboard. Like-wise, where the general-purpose computer is implemented in a mobile smart-phone such as an IPHONE running iOS, such a general-purpose computer would likely not include a mouse and a printer. One of ordinary skill in the art will understand that the description provided herein are descriptive of components that may be use in a computer.

Embodiments of the present disclosure may include programs that may be stored in the RAM 214, the ROM 216 or the drives 222 and may be executed by the processor 212 in order to carry out functions described herein. The communications link 228 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; any combination of the preceding; or other. Drives 322 may include a variety of types of storage media such as spinning disk drives, a solid-state drive, removable memory cards (including SD, micro-SD, or the like), or other suitable drives for storage. Although this embodiment employs a plurality of drives 222, a single disk drive 222 may be used without departing from the scope of the disclosure such as a RAID (“Redundant Array of Inexpensive Disks”) drive.

Although FIG. 2 provides one embodiment of a computer that may be utilized with other embodiments of the disclosure, such other embodiments may additionally utilize computers other than general purpose computers as well as general purpose computers without conventional operating systems. Additionally, embodiments of the disclosure may also employ multiple general-purpose computers 210 or other computers networked together in a computer network. The computers 210 may be servers or other types of computing devices. Most commonly, multiple general-purpose computers 210 or other computers may be networked through the Internet and/or in a client server network. Embodiments of the disclosure may also be used with a combination of separate computer networks each linked together by a private or a public network.

Several embodiments of the disclosure may include logic contained within a medium. In the embodiment of FIG. 2, the logic includes computer software executable on the general-purpose computer 210. The medium may include the RAM 214, the ROM 2316, the disk drives 222, or other mediums. In other embodiments, the logic may be contained within hardware configuration or a combination of software and hardware configurations.

The logic may also be embedded within any other suitable medium without departing from the scope of the disclosure.

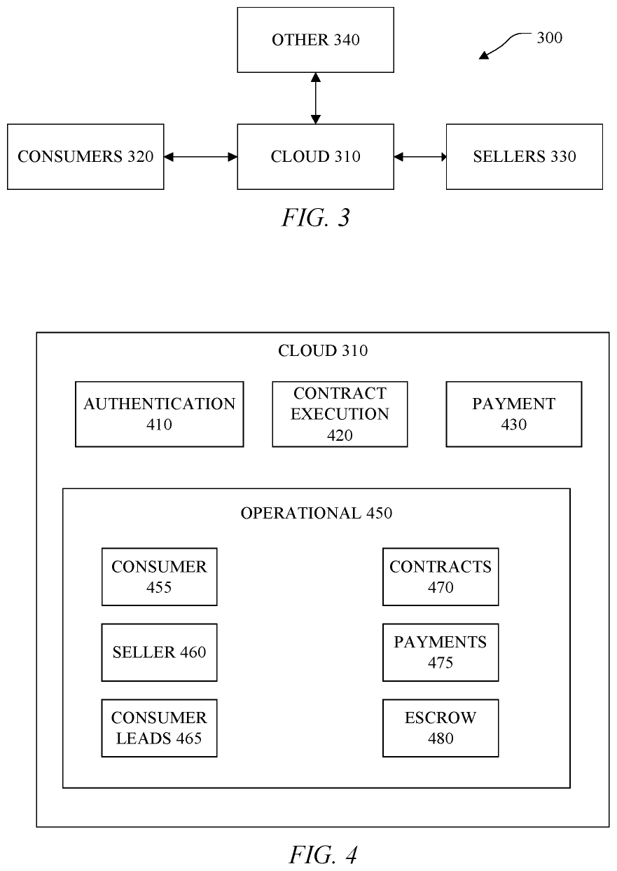

FIG. 3 is block diagram of a system 300, according to an embodiment of the disclosure. The system 300 includes at a high level, a cloud 310, sellers, 330, consumers 320, and other entities 340. Each of the cloud 310, seller 330, consumers 320, and other entities 340 may generally correspond to endpoints of FIG. 1 with logic executed on general-purpose computers describe with reference to FIG. 2. As a non-limiting example, the cloud 310 may be a series of servers hosting the systems and executing the functions described herein.

The cloud 310, for example, may be server(s) running remotely from the consumers 320 and sellers 330. The sellers 330 and consumers 320 may respectively utilize an interface on their respective devices (e.g., via an application or a web interface) to communicate with the cloud 310. In particular configurations, the sellers 330 and consumers 320 may create accounts that are stored on cloud 310, accessible through suitable authentication.

The consumers 320 provide information about themselves to the cloud 310. The sellers 330 may generally correspond to any entity or person that can provide a product, service, or property to the consumers 320. Non-limiting examples include vehicle rentals, vehicle leases, real estate leases, and yet others that will become apparent to one of ordinary skilin the art having reading this specification.

The consumer 320 wants the best possible price and the sellers 330 seeks to competitively provide amongst possible other sellers. However, the consumer 320 may not provide quite enough information to allow the seller to provide a competitive bid. Accordingly, the other the other component 340 fills the gap to supplement information that the user can provide. Virtually any possible information can be provide to the cloud 310 for facilitating the consumer-seller arrangement that is neither provided by the consumer nor the seller such as, but not limited, to credit reports of the consumer, past-history with the consumer, rental/lease market conditions, ratings associated with the consumer, rating associated with seller, and information from other systems that a current consumer may be using. Yet further types of information will be described below. In particular configurations, some, none or all of the other 340 component may be part of the cloud 310 itself.

With the vastly evolving marketplace, in one particular configuration, all or some of the other 340 may exist on a blockchain that stores information on particular consumers by a unique identifier (as opposed to personally identifiable information such as name, sex, address). Any suitable authentication mechanism can be used for the consumer 320 to access and share that information with potential sellers including, but not limited to, passwords or private keys. In such embodiments, one benefit is the fact that the blockchain need not be centralized. To protect the information on the blockchain itself, the data can be encrypted. In other embodiments, more traditional information may be obtained, for example, crediting reporting agencies and the like.

Based on the information provided by the consumer 320 and other 340 component, a seller 330 may engage in any sort of analysis it prefers on bidding for the consumer 320. In some configuration, the sellers 330 may have its own custom algorithms and artificial intelligence for things it considers important in competitive bidding for the consumer.

In other configurations, either the other 340 component and/or cloud 310 may provide information not generally available to seller 330 such as real-time or historical market conditions for the particular product, service, or property. As a non-limiting example, as more and more transactions are consummated, such information can be used as a real-time feedback into current market conditions. Likewise, the system can sense historical trends in the marketplace. Such information can be provided to one or both of the consumer 320 and seller 330.

In particular configurations, the interactions of one or both of the consumers 320 and sellers 330 with the cloud 310 may be via a web-interface and/or an application such a smart phone application that is loaded onto a smart phone such as an iOS or Android-based phone. In particular configurations, consumers 320 and sellers may be able to access in both manners as will be recognized by one skilled in the art. For example, consumers 320 and sellers 330 may be able to access their respective accounts through an application on smart phone and through a web interface using login credentials.

A consumer 320 who wishes to purchase/lease/rent accesses the cloud 310 at a remote server. The consumer 320 may submit an application that contains information required for the cloud 310 to run a credit and background check (e.g., pulling from the other component 340) on the consumer 320 and communicate the results of the same, together with the consumer's terms, to multiple sellers 330 selected by the consumer 310.

As one non-limiting example, a consumer 320 may specify that it wishes to rent a one-bedroom apartment within a particular geographic area and then fill out an application and authorize a credit check. The information, including the results of the credit screening (collectively, a “Consumer Lead”) would be transmitted to the cloud 310, provided that all identifying and personal characteristics of the consumer (i.e., name, race, sex, etc.) would be removed from the Consumer Lead. While such information is included in a Consumer Lead in certain embodiments, it should be understood that Consumer Lead may include different information in other embodiments.

The Consumer Lead may be transmitted via numerous means (e.g., using channels described with FIG. 1) including a world-wide-web interface, electronic mail, voice mail, text message, smart phone applications (e.g., via push notifications—either through and app or browser-based push notifications). Standard legal provisions and language are then integrated with the Consumer Lead to “fill in the gaps” of the consumer's inquiry. Alternatively, the Consumer Lead may be developed further while the consumer is on-line with the central controller.

Before communicating the Consumer Lead to potential sellers 330, the cloud 310 may confirm the identification of the consumer 320 and/or the seller 330 against appropriate databases, for example, that may be associated with the other 340 component.

The cloud 310 may assign a unique tracking number to the Consumer Lead and globally display the Consumer Lead in a manner such that it is available to be viewed by any interested potential sellers 330. Consumer Leads may be displayed by subject category to make it easier for potential sellers to identify relevant Consumer Leads. Thus, a seller 330 could log onto a website, for example, and see a listing of Consumer Lead subject categories. The seller could then choose a particular subject and have the ability to browse Consumer Leads which correspond to that subject category. In one embodiment, the seller may be required to provide qualifications in order to view the Consumer Leads of a given subject category. Such qualifications could be checked against the other 340 components.

If, after reviewing a particular Consumer Lead, a potential seller wishes to make an offer to the Consumer Lead, the seller 330 provides the material terms of the offer and submits the same to the consumer 320. The cloud 310 may timestamp the message from the seller 330 and authenticates the identity of the seller and his capacity to deliver the product sought by the consumer 320. The system then verifies that the particular Consumer Lead is still “active” (i.e., the consumer has not previously accepted an offer from another seller) and communicates the information to the consumer as described above—world-wide-web interface, electronic mail, voice mail, text message, smart phone applications (e.g., via push notifications—either through and app or browser-based push notifications).

A Consumer Lead is “completed” when the consumer 320 accepts a seller offer. Subsequent sellers will not be able to offer a “completed” Consumer Lead. The consumer's acceptance of seller's offer would be subject to review and approval of the relevant transaction documents. In particular, configurations, the seller 330 prepares a transaction document incorporating the terms of the offer and submit same to consumer for execution. In particular configurations, then seller 330 may provide a lease template to the cloud 310 to automatically populate with information concerning the accepted terms and the identity of the consumer 320 for execution. The contract terms can be provided prior to the consumer's acceptance. A copy of the consumer's application and credit screen results may be provided to the consumer as well in certain configurations.

Consumer 330 and seller 320 then execute the contract. In particular configurations, such an execution may be automated using electronic signatures (e.g., Docusign) or a similar electronic signature component directly within the cloud 310 (as allowed by applicable laws). In other configurations, a contract can be sent for wet-ink signatures with later appropriate exchange—using the cloud 310 system or not. Non-limiting examples include uploading images to the cloud 310, emailing or faxing images 310 to the cloud, or simply placing the executed contract in the mail. In certain configurations, regardless of execution formation, a digital copy is included is ultimately stored in the cloud 310.

Commensurate with execution, the consumer 320 would also deposit the relevant security deposit and fees (e.g., first-month's rent) with the cloud 310. Upon successful completion, the cloud 310 can (i) distribute the fully executed contract to the parties, (ii) disburse the applicable security deposit and fees to seller and (iii) assign a unique tracking number to the contract. The lease contract is then stored in a database associated with the cloud 310. The consumer and seller are now parties to a legally binding contract.

In certain embodiment, the cloud 310 manages the payment system between the consumer 320 and seller 330 automatically. Various methods of payment may be utilized, including credit cards, personal checks, electronic funds transfer, debit cards, and digital cash. The payment system may also involve the use of an escrow account associated with the consumer wherein funds advanced by the consumer to cover any up-front costs, such as a security deposit, can be kept pending acceptance by a qualified seller. Moreover, the timing of payment to the seller can be varied. The seller 330 can be paid immediately after the consumer 320 accepts the seller offer or payment can be delayed until after the seller executes the contract.

While no negotiations are allowed in certain configurations, in another embodiment, negotiations and counteroffers may be passed back and forth between the sellers 330 and consumers 320 as described below. In particular configurations, such options may be defined by the sellers 330.

In certain configurations, protocols are used to authenticate the identity of consumers and/or sellers and verify the integrity of consumer and seller communications with the cloud 310. Non-limiting examples include the use of cryptography, biometrics, and two-step verification techniques. In such configurations, the cloud 310 can make it significantly more difficult for unauthorized persons to tamper with the system by passing themselves off as legitimate consumer or seller or eavesdropping on system communications. As an example of the proceeding, upon registering and authenticating identity, a particular piece of information such a phone number or authenticator app (e.g., Duo or Google Authenticator) can be tied to an individual in addition to a username/password. Alternatively, a fingerprint may be associated with a log-in for a user in an application on a smart phone—as will be recognized by one of ordinary skill in the art.

In particular configurations, anonymity is an advantage. For numerous privacy and competitive reasons, consumers and sellers often prefer not to have their identities revealed to the general public when engaging in commercial transactions. Certain embodiments effectuate the anonymity of consumers and sellers through the use of identification numbers stored in a database secured by the central controller that respectively correspond to a seller and/or consumer. Such numbers may not be disclosed the public—for potential posting on public web sites and unmasking of identifies associated with and consumer and/or seller.

In certain embodiments, there is no transfer of money from a consumer to a seller. Instead, the system may be used to consummate a contract involving an exchange of goods, services, or other non-monetary consideration. In other configurations, the system contemplates the transfer of money.

Certain configuration of certain embodiments essentially auction a prequalified consumer to multiple sellers. A consumer takes its unique qualifications and terms and market such to multiple sellers in order to achieve the best price. In such configurations, sellers will accept less for quality and more immediate income, and the present invention allows consumers to advertise their qualities and terms to multiple sellers to achieve the best pricing. No hassles. No negotiations.

Certain configurations may also provide a consumer 320 immediate offers once they have been authenticated and appropriate additional information can be supplied. In such scenarios, a seller 330 can have artificial intelligence, pre-configured offers or algorithms to offer a certain deal if criteria have been met. As to the advantageous nature, the consumer 320 on a website can be immediately offered a deal—either through the website or the in the form an advertisement specifically for the individual. As a non-limiting example, a consumer 320 can provide a specific automobile and certain number of annual miles he or she wants in an auto-lease. When basic information concerning the consumer 320, which may include a credit check (or other information that a dealership might want), multiple dealers (sellers 330) can “bid” on the pricing for such a lease. And, the consumer 320 can choose to immediately accept the offers for such bids and consummate the transaction entirely online. After such consummation, the address of the consumer can be provided and the automobile can be delivered.

Certain configuration of certain embodiments also allow consumers to reach a large number of sellers, including sellers of units of a quality or class that the consumer may not otherwise typically consider, but because of the quality of the consumer or available inventory, such sellers may be willing to compromise on price. For instance, this might be the case for a consumer who could precisely define the type of apartment unit it wants. Certain configurations allow such a consumer to issue an inquiry that is globally communicated to sellers in a particular area. Any one of those sellers could then review other seller offers and decide whether or not it can compete. The consumer's advantage is particularly significant when certain of sellers have more inventory than others. Consumers could use such configurations of the disclosure to cast a wide net to reach dozens of sellers and potentially find a product that would have typically been out of consumer's price range, but the seller is willing to satisfy the consumer's requirements because of the unique qualities of the consumer, then existing inventory/vacancy and/or other reasons.

Certain configurations provide a robust system that matches consumers' qualifications and requirements with sellers capable of satisfying those requirements at the best rate. In such configuration, a global bilateral consumer-driven system for creating binding contracts incorporates various methods of communication, commerce and security for the consumer and the seller. The power of a central cloud to deliver screened consumers to multiple sellers in an anonymous manner, field binding offers from sellers and consumers, communicate those offers in a format which can be efficiently accessed and analyzed by potential consumers, effectuate performance of resulting contracts, and maintain billing, collection, authentication, and anonymity makes the such configurations of the disclosure a significant improvement over conventional systems.

The logic may also be embedded within any other suitable medium without departing from the scope of the disclosure.

FIG. 4 shows further features of the cloud component 310 of FIG. 3. As described above, the cloud 310 may be multiple servers operating on the features described with reference to FIG. 2—communicating using the feature described with FIG. 1. As one of ordinary skill in the art will recognize, the term server can refer to software, hardware, or a combination. The use of the term “server” herein should not be limited to only a particular machine or software configuration. Certain modules described herein may be on a different machine or a different module.

The cloud 310 of FIG. 4 is shown with four major architectural component pieces: authentication 410, contract execution 420, payment 430, and operations 450. While such is provided, one of ordinary skill in the art will recognize that other architectural representation can be provided for the feature described herein.

In certain pieces, authentication 410 may utilize hardware pieces that differ than those used by contract 420, payment 430, and operations 450. In certain configurations, authentication 410 may simply communicate with another external component and/or server to verify a user is who he or she says she is. In particular configurations, authentication may include typical username/password authentication. In other configurations, authentication may include a second step of authentication such as email, text message, or authentication fob or app (e.g. with rolling codes tied to a unique number). Authentication 410 may involve two roles—one during initial sign-up and another for logging into an account. The former may trust information from a particular user (e.g., a phone number) or rolling codes from an authenticator app for rolling codes. One of ordinary skill in the art will recognize other manners of authenticating commensurate with this disclosure such as OpenID or OAuth.

Contract execution 420 harnesses the vastly changing way that society is moving away from paper environments. Where allowed by law, the entire contract between a seller and consumer may be executed digitally, for example, using either the cloud 310 or a third-party system (e.g., Docusign). One of ordinary skill in the art will recognize how APIs (“Application Program Interface”) can be used to integrate with other third-party systems to pass and receive information.

Cloud 310 can alternatively receive images of electronically or physically signed documents for storage, for example, with reference to contracts 470 discussed below. In particular embodiments an executed physical contract can be received via email, fax, or upload. In one configuration, an application on a smart phone can be enabled to take a picture directly in the application—similar to how one would remotely deposit a check. Upon receipt of such images, contract execution 420 may verify that the correct signatures are present and, also, compare what is present in the upload images to what was sent. This verification step may eliminate the need to come and check for errors.

Payment 430 supports the transfer and exchange of payments, charges, or debits. In particular configurations, payment 430 communicates with either banks or payment processing companies (e.g, Braintree, Square, Stripe, Paypal, Forte, Authorize.net) to facilitate transaction handling. In certain configurations, payments are held at an intermediate staging location attending to other conditions being met commensurate with the contract. In yet other configurations, payments may be made directly between a consumer and seller (e.g., through their respective institutions). In yet another configuration, an account associated with the system described herein can be created. In some configurations, payment 430 may incorporate cryptocurrency payments.

As will be recognized by one of ordinary skill in the art, these payment processing services can provide on-line account statements, order-taking and credit card payment authorization, credit card settlement, automated sales tax calculations, digital receipt generation, and account-based purchase tracking.

Operations 450 includes multiple sub-component pieces, including consumer 455, seller 460, consumer lead 465, contracts 470, payments 475, and escrow 480. Each of these may be incorporated in any suitable storage and may be implemented through one or more databases.

Consumer 455 maintains information on consumers such as, but not limited to, name, address, credit card number, phone number, ID number, social security number, electronic mail address, credit history, past system usage, etc. This information is obtained when the consumer first registers with the system, or immediately prior to posting his first consumer lead. As described above, such information may be obtained partially through the consumer and partially through other information 340. Consumer 455 also include a unique identifier for each consumer. And, in certain configurations, rating information and/or information on past interactions may be maintained such as, but not limited, to payment history (e.g., which may be extracted from Payment 430).

Consumer 455 also contains the tracking number of each consumer lead 100 generated by the consumer, and the tracking number of each seller response and counteroffer directed to the consumer lead. The information in consumer 455 may be used for a consumer account—pulling information for display to a particular user and/or allowing a user to update information (e.g., bank account or checking account information for payments).

Seller 460 maintains information on sellers with such as, but not limited to, name, contact information, payment preferences, type of business. Contact information may include, but is not limited to a phone number, web page URL, bulletin board address, pager number, telephone number, electronic mail address, voice mail address, facsimile number, or any other way to contact the seller. Upon registration, the seller may be required to demonstrate evidence of ability to deliver on consumer leads. As a non-limiting example, a property tax records or other evidence may be submitted. In certain configurations, the cloud 310 may do this automatically by checking public records on property ownership (e.g., county appraisal district). Seller 460 also include a unique identifier for each seller. And, in certain configurations, rating information and/or information on past interactions may be maintained.

The information in seller 460 may be used for a seller account—pulling information for display to a particular user and/or allowing a user to update information (e.g., bank account for receipt of payments).

Consumer Leads 465 tracks all Consumer Leads with stored information such as status, tracking number, date, time, subject, price, expiration date, conditions, and consumer identification number. This information is valuable in the event of disputes between consumers and sellers regarding payment, because details of the interactions can be provided. Consumer Leads also stores offers, counteroffers and seller responses such as seller name, seller ID number, date, time, seller response tracking number associated with the consumer lead tracking number.

Contracts 470 tracks the messages sent to the consumer and seller confirming completed transactions (bound contracts) as well as the actual consummated contract. Non-limiting information includes, but is not limited to consumer name, consumer ID number, seller name, seller ID number, purchase confirmation tracking number, and associated consumer lead tracking number. Contracts also includes form background provisions for inclusion in consumer leads. These form provisions effectively fill the gaps between conditions specified by the consumer, specifying the generic contract details common to most consumer leads.

Payments 475 tracks all payments made by the consumers and includes information such as consumer name, consumer ID number, amount of payment, and associated consumer lead tracking number. In particular configurations, payments 475 may also store payment credentials (e.g., credit card numbers, checking account numbers). Payments 475 may interact with payment 430 for updating payments 475.

Escrow 480 contain information on temporarily holds of consumer funds before they are placed in seller account.

As will be recognized by one of ordinary skill in the art—especially dealing with financial information, the particular modules described above may utilize appropriate payment and/or banking APIs to execute described functionality. As an example, whereas an account associated with the system may appear to have money, the funds are actually held at bank with the API providing information and interaction concerning such funds. Similarly, whereas as credit card or financial transaction will appear to take place through the system, the operation is occurring using an API of payment process (e.g., Braintree or others) that handles the back-end transaction. One of ordinary skill in the art will recognize how one system may interoperate in secure manners to effectuate such operations.

According to embodiment of the disclosure, communications between consumers and sellers take place via electronic networks, with the cloud 310 acting as the intermediary. Again, the cloud 310 may be multiple servers. The consumer logs on cloud, creates a consumer lead, and then disconnects from the network. The consumer lead is then made available to potential sellers by sharing amongst potential sellers. In particular configurations, the potential sellers are those that have already created account with the cloud 310. As will be recognized by one of ordinary skill the art, chron jobs (or similar features) can be performed to ensure that active consumer leads have not expired. Also, a variety of mechanisms can be put in place to ensure that the consumer has sufficient credit available to pay a seller who elects to bid on a consumer lead. Seller responses are transmitted electronically through the cloud 310, which contact the consumer with the offer. Once an offer is accepted, the payment 430 of cloud 420 can handle payment.

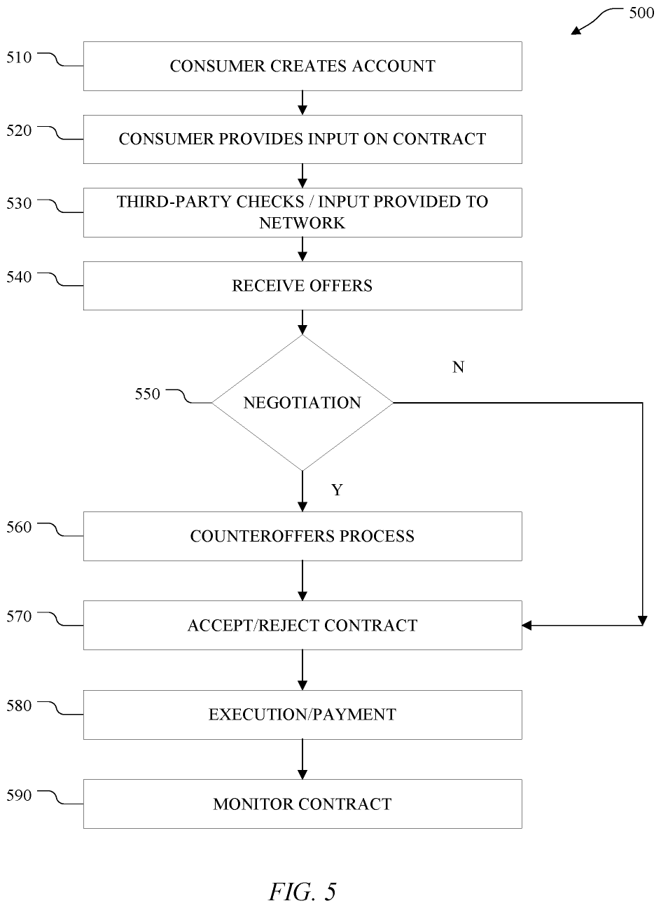

FIG. 5 illustrate a process of consumer creating a lead, according to an embodiment of the disclosure.

At process 510, the prospective consumer creates an account by interacting with the cloud 310. This process 510 can be done either through an application (e.g., on an Android Phone or an iPhone) or through a web interface. A typical process involves creation of a username and password. A variety of information such as email and phone number can be shared. The cloud 310 can verify a phone or email by sending verification codes. In the account creation process 510, any of variety of identity verification processes may be also carried out. For example, as will be recognized by on of ordinary skill in the art, a driver's license can be verified. In some configurations, a consumer may be required to upload a driver's license; in other configurations, no such requirement may necessary. Also, a soft credit pull can be carried out to question the consumer as to information concerning a particular user. While such verification may be done in certain configurations, it should be understood that not all configurations may have such a step. As part of the account creation process 510 (or a later time), a user can turn on two-step verification.

In some configurations, some, none, or all of the following additional information may be gathered: name, driver's license, social security number, current address, current employer, school transcripts, name of cosigner. In particular configurations, by providing this information up front, the additional data will not be needed to be added again—unless to simply update the information. Stated differently, some of this information may be used as part of the consumer lead. It should be noted that just because information has been gathered in the account creation process does not mean that such information will be communicated to the seller.

As referenced above, as part of the account, consumers (and sellers) can have ratings. An initially created account may have no rating because there is no prior experience.

At process 520, a consumer provides information on what he or she is looking for—input for a contract. In the real-estate context, non-limiting examples of types of information that can be provided include, some, none or all of the following: number of bedrooms, number of bathrooms, pets, washer/dryer, location, price, home type, size, pool, parking, hobbies, and interest. Yet other information can be selected. And, in particular configuration, a user may be able to provide free-text notes of non-listed preference. For vehicle lease information, other types of information can be supplied such as vehicle type, year, model, term and desired annual miles, amongst others. In yet other configurations, other types of information can be provided. This specification is not limited to any one type of goods, service, or property. Rather, other types of goods, service, or property can avail from the teaching of this disclosure.

In certain configurations, the information provided by a prospective consumer can be ran across potential matches in the network and a user can select preferences. As a non-limiting example, for an automobile lease, availability of automobiles that sellers are currently bidding on may be provided to the consumer 320. As another non-limiting example, for an lease of property similar to the criteria provided, multiple units with a percentage match can be provided an a consumer can indicate which ones they are interested in receiving competitive bids.

At process 530, according to particular configurations, additional information on the consumer can be obtained. In particular, information not-directly provided by the applicant can be obtained. As reference above, virtually any information that may be important to a seller 330 may be supplied—provide that such information does not violate any applicable laws. Non-limiting examples in rental unit may be employment verification, credit check on the prospective consumer and co-signer. Additionally, to the extent available, renter history may also be obtained. In yet further configuration, a risk score may be provided based on length of transaction history. For example, some configurations may provide a lower risk score when more information is known about a particular user, which may come through prior transactions through the system itself—another loopback principal. The information obtained at process 530 in particular configurations may be designed to give prospective sellers incentive for lower bid prices for desired consumers—a win, also for the consumer.

With the information in process 510, 520, and 530, a consumer lead is created as described above. The consumer lead is sent to prospective sellers and the bidding process begins.

At process 540, the consumer receives offers. The notification may be via email, text, or any other suitable mechanism. In one configuration, the prospective consumer can log-on to his or her account (or application) and see how many bids are present and a listing. A ranking may be provided to see what percentage of match to parameters—with 100% being everything met. Lower percentages can be provided for lower matches. The consumer may be able to view additional information on each offer with the notifications as to what matched and what didn't match (in the case the match is less than 100%). Such notification may be provided in any particular configuration. In certain configurations, the notifications may be instant on a webpage or via a customized advertisement to the consumer.

Amongst additional offer information that may be provided is some, none or all of the following: the name of the place, the current going rate, the offer, the match percentage, a link to the website associated with information (if applicable), further details about the product, notes form the seller, and a date to accept the offer. Yet additional information may also be provided.

The prospective consumer may be given the option to accept the offer, decline the offer, message seller, or provide a counter-offer (if the consumer is willing to accept). Further details of each are provided below.

At process 550, in particular configurations, the seller might be willing to accept a counteroffer. In other configurations, a seller may not be willing to accept counteroffers. If a negotiation process is allowed, a counteroffer process 560 may be utilized with a back and forth through multiple possible counteroffers on process. In this process, according to particular configurations, notes may be provided.

If no negotiation process is allowed or the counteroffer process has ended, process 570 is engaged there is either an acceptance or rejection of the offer. If the offer is accepted, the cloud 310 update the records in the case the same unit is being offered elsewhere. This is because in particular configurations, the same unit may be offered to multiple different potential consumers. In particular configurations, such information may or may not be provided to the prospective consumer. If the offer is rejected, it may be removed from the consumer's bid and/or stored in a history of rejected offers.

At process 580, if the offer is accepted, the process of executing the contract and initiate payment begin. As described above, the execution of the contract may be done completely electronically through the cloud 310, through a third-party system (e.g., Docusign), or through other mechanism (e.g., sign and upload, fax, email etch).

The payment process may include providing a credit card number or bank account for the first-month deposit, first month's rent, amenities, etc. In particular configurations, such information may also be supplied for ongoing payments (e.g., every month) up to the end of the contract. The payment information may take advantage of any of the payment details described above—be it third party or the like. Once the payment information clears, further information may be provided such as an email from the seller and details on inhabiting the rental/lease unit. In one configuration, a networked digital lock may be used on door; and, the unlock code may be provided to the new consumer.

In particular configurations, further contact between the consumer and seller may be maintained through the system to monitor the contract at process 590 As a non-limiting examples, renewal options may be communicated to the consumer and seller. Stated differently, the cloud 310 may allow a renewal of a contract for ease on both a seller. In such scenarios, auto-notifications of non-renewals of contracts can be communicated on behalf of one or the other. Additionally, in particular configurations, the notification of non-renewal by the consumer allow the seller to begin the re-listing process through the system through the bidding process.

A consumer that chose to look for new options—having already created and account. Likewise, positive history on a particular contract can be stored by the system and be provided to prospective sellers as a risk factor in a subsequent transaction. Thus, as will be recognized by one ordinary skill in the art, the current transactions in the system may serve as input for future transactions including, but not limited to current market conditions, historical market trends, and risk score associated with specific consumers.

Each of the consumer and seller can also rate the other on the particular interaction for the contract on a star rating. And, the star rating in particular configurations may be used as criteria for either the seller or consumer. As an example, a consumer may choose to only do business with highly rated sellers. The star rating in particular configurations may be part of separate from a risk score.

Over time, the consumer can update information in the system. As a non-limiting example, where payment is done through the system, a consumer can update payment information. Additionally, as part of a contract, a setting can be provided to automatically communicate non-renewal unless the consumer changes.

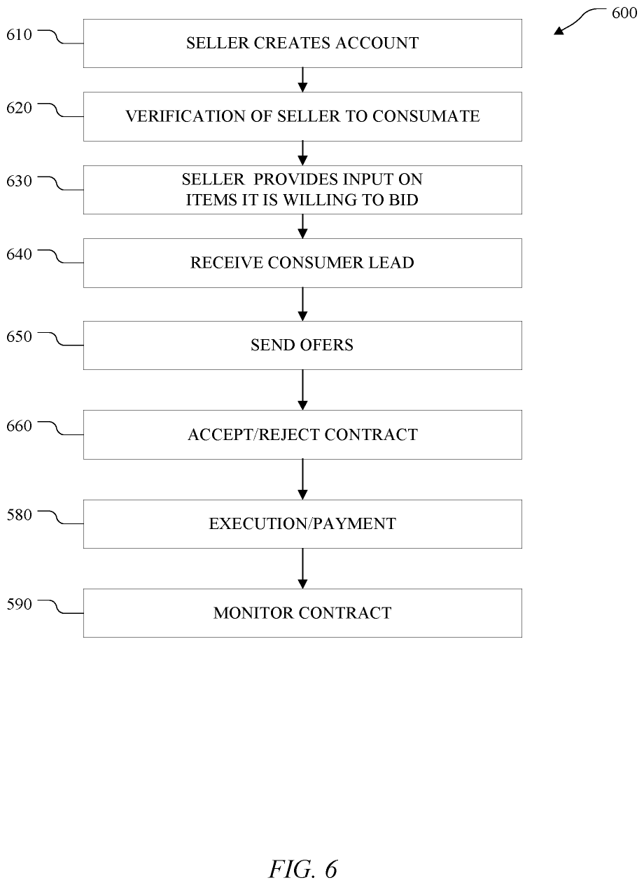

FIG. 6 illustrate a process of a seller bidding on a consumer lead, according to an embodiment of the disclosure.

At process 610, the prospective seller creates an account by interacting with the cloud 310. This process 610 can be done either through an application (e.g., on an Android Phone or an iPhone) or through a web interface. Similar to the consumer creation process, a typical process involves creation of a username and password. A variety of information such as email and phone number can be shared. The cloud 310 can verify a phone or email with a particular by sending verification codes. In the account creation process 610, any of variety of identity verification processes may be also carried out similar to those described above with the consumer.

At process 620, there may be a verification process of the ability to consummate the transaction. For example, if the transaction is for real estate, the system may examine the ability to let the property in question. As described above, this may be at least manually carried out by the seller submitting proof of ownership. Alternatively, in some configurations, this may be done automatically. In the account creation process, the prospective seller can also sign a contract that he or she will only provide properties he or she is allowed by law to rent. Similar verification process can be done for other items.

At process 630, the seller provide input on the particular of items for which it is wiling to bid. Multiple listings may be created for a single account where a seller has multiple products, properties, or services. In other configurations, the information may only come to the seller as a result of a particular item being bide on. The system may alternatively support both configurations

Further details illustrating certain aspect of the disclosure are attached as Appendix A, Appendix B,

In particular configurations, some of the data for details on a particular property can be automatically read from a currently-used listing website (e.g., to avoid repeat work). In such configurations, the seller may be allowed to simply provide a URL that can be data-scraped.

When such data is pre-populated from data from another site, the seller can be provided a verification process to verify detail associated with the property. The details associated with a property can be similar to those identified by the consumer as wants.

In scenarios where no information is provided, a seller can enter all the data for the first time. Through repeated transactions through the system, the data need not be re-entered.

In addition to the property information, the seller can enter information on desired leads such as a credit range, a monthly income range as a function of rent (e.g., 2 times, 2.5 times, or 3 times), and to the extent available no prior evictions on background reports.

At process 640, the seller receives one or multiple consumer leads for the property, service, or item. While not providing personally identifying information, the consumer lead may include a credit score, monthly income, and other information obtained from a background check. In particular configurations, the consumer leads may also have a match score on input for consumers. In other configurations, no such score may be provided.

In addition to the consumer lead, in particular configurations, pricing profile information (e.g., top competitor) may be provided on similar products/properties or averages for the current market. Such information may be particular for particular sellers having difficulties finding an appropriate price. In particular configurations, a suggested price may be automatically calculated for a seller based on the consumer particulars and the current marketplace. The current marketplace information may either from the cloud 310 processing and handling other contracts or third-party information.

At process 650, the seller may choose to send and offer in response to the consumer lead. In sending the offer, in particular configurations, the consumer lead may choose to send a note and, also, define whether he or she is willing to engage in a negotiation process. If negotiation is not allowed, the consumer will understand that no negotiation is being allowed.

At process 660, the consumer either accept or reject the offer (which may be a counteroffer—depending on the configurations).

Process 670 and 680 is the same processing as 580 and 590 except from the sellers's perspective.

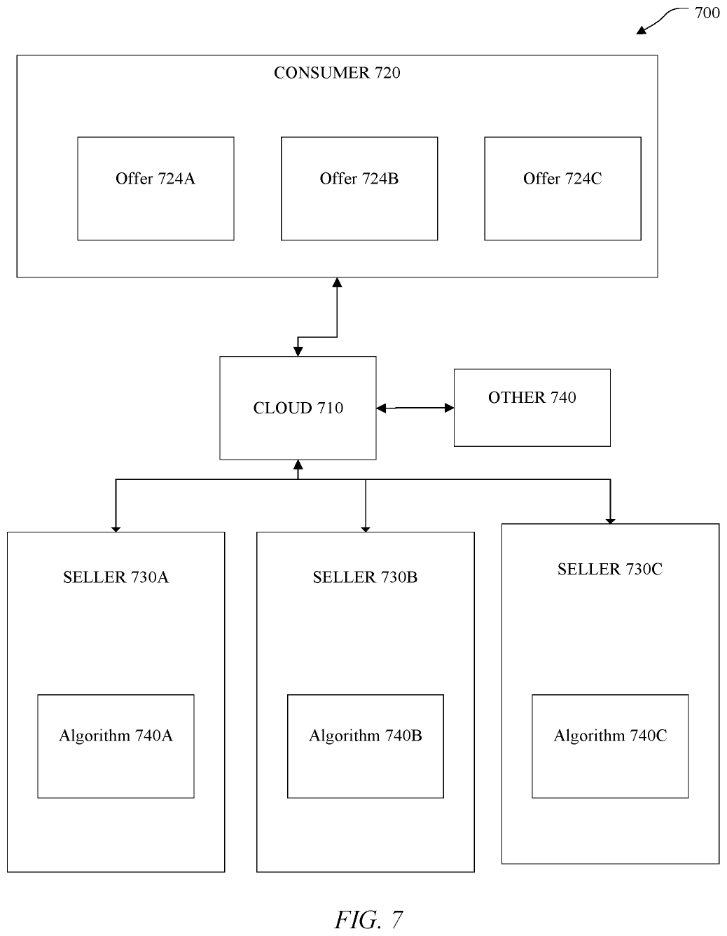

FIG. 7 is a simplified diagram of multiple sellers 730A, 730B, and 730C bidding on a particular consumer 720. The system 700 of FIG. 7 is similar to the system 300 of FIG. 3 with the following additional details provided. Each of the sellers 730A, 730B, and 730C may have their own artificial intelligence or algorithms 740A, 740B, and 740C for bidding on the particular consumer. In particular configurations, artificial intelligence or suggested criteria for an algorithm may be supplied—including information that seller may not know is available. The system may additionally provide information on correlation between particular types of data on risk factors—suggesting the more important criteria and allowing the seller to select which ones are more important.

In particular configurations, a seller may seek additional information it would like for providing a bid, which the system may gather—if allowed by law. In particular configurations, such additional information may be requested directly of the consumer 720. In other configurations, the additional information, if available, may be gathered from the other components. The system itself can be dynamic to change to facilitate the type of exchange of information that yield competitive bids. Sellers themselves that dynamic change by informing the system as to what information is important for providing more competitive bids.

After the information of the consumer (and the particular item—e.g., product, service, or property) is communicated to the sellers, each seller can calculate its bid. In particular configurations, the bid can be automatic based on the criteria and multiple if/then determinations. In other configurations, some manual intervention may be required such as a confirmation to send a particular bid.

In particular configurations, timeliness of the bid may be important to the consumer and instantaneous offers such as Offer 742A, 742B, and 742C may be supplied on a website the consumer is viewing. Where a seller is completely automated with their algorithms or artificial intelligence, a very particular bid may also be communicated in a form of advertisement that is unique to the consumer.

It will be understood that well-known processes have not been described in detail and have been omitted for brevity. Although specific steps, structures and materials may have been described, the present disclosure may not be limited to these specifics, and others may substitute as is well understood by those skilled in the art, and various steps may not necessarily be performed in the sequences shown.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

It will be understood that well known processes have not been described in detail and have been omitted for brevity. Although specific steps, structures and materials may have been described, the present disclosure may not be limited to these specifics, and others may substitute as is well understood by those skilled in the art, and various steps may not necessarily be performed in the sequences shown.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. Logic encoded in computer readable media such that when executed by one or more processors:
electronically receives requirement information of a consumer for a requested asset;
electronically receives qualification information of the consumer for the requested asset; and
electronically communicates at least some of the requirement information and qualification information of the consumer to a plurality of sellers;
electronically receives, from the plurality of sellers, a plurality of bids for the consumer for the requested asset; and
electronically communicates, to the consumer, the plurality of bids for the consumer for the requested asset.

2. The logic of claim 1, when executed by one or more processors:
electronically receives, from the consumer, either an acceptance or rejection of one of the plurality of bids.

3. The logic of claim 2 wherein
the consumers are tenants, and
the requested asset is real estate.

4. The logic of claim 3 wherein the sellers are landlords.

5. The logic of claim 1, when executed by one or more processors:
electronically communicates, to the consumer, a ranking associated with the plurality of bids for the consumer for the requested asset, the ranking based on a combination of a price of the bid and a matches between parameters of the asset requested by the consumer and the available assets by the sellers.

6. The logic of claim, when executed by one or more processors:
when an acceptance of one of the plurality of bids is received, electronically consummates a contract between the seller and consumer.

7. The logic of claim 6, when executed by one or more processors:
gathers an initial payment for the contract pursuant to the contract.

8. The logic of claim 5, when executed by one or more processors:
electronically receives, from the seller, a counteroffer corresponding to a bide for the available asset corresponding to the requested asset.

9. The logic of claim 1, wherein the qualification information communicated to the one or more sellers lacks personally identifiable information.

10. The logic of claim 1, wherein the qualification information communicated to the one or more sellers does not include a person's name, religion, color, sex, national origin, disabilities or familial status.

11. The logic of claim 1, wherein the at least some of the qualification information communicated to the one or more sellers includes a credit score, salary, and work history.

12. The logic of claim 1, wherein the at least some of the qualification information communicated to the one or more sellers includes a rating based on past interaction the consumer had with the system.

13. The logic of claim 1, wherein at least some of the qualification information is received from the consumer and at least some of the qualification information comes from a source other than the consumer.

14. The logic of claim 1, when executed by one or more processors:
verifies at least some of the qualification information from a source other than an original source through which it was received.

15. The logic of claim 1, when executed by one or more processors:
calculates qualitive scores of matches between parameters of the asset requested by the consumer and the available assets by the sellers; and
electronically communicates the qualitive scores with the plurality of bids.

16. The logic of claim 1, when executed by one or more processors:
receives a listing of available assets from the one or more sellers,
validates the one or more sellers have the right to contract with the listing of available assets.

17. The logic of claim 1, when executed by one or more processors:
suggests a bid price to the seller based on market trends.

18. The logic of claim 1, when executed by one or more processors:
suggests a bid price to the seller based on a feedback loop of prior transactions within the system.

19. The logic of claim 1, when executed by one or more processors:
suggests a bid price to the seller based on other offers bids made to the seller for the consumer for the requested asset.

20. The logic of claim 1, when executed by one or more processors:
for completed transactions, receives from each of the consumer and seller ratings on the other.

21. The logic of claim 20, wherein the ratings are used as filters for future transactions.

22. The logic of claim 1, wherein the asset involves a lease.

23. The logic of claim 22, wherein the asset is real estate.

24. The logic of claim 1, wherein the asset is a purchase of property.

25. (canceled)

26. The logic of claim 25, wherein the requirement information is dynamically updateable based on input from the one or more sellers.
